(19) United States
(12) Patent Application Publication
(10) Pub. No.: US 2024/0210807 A1
(43) Pub. Date: Jun. 27, 2024

(54) PROJECTOR

(71) Applicant: SEIKO EPSON CORPORATION, Tokyo (JP)

(72) Inventors: Kana HATANO, Matsumoto-Shi (JP); Eiji MORIKUNI, Matsumoto-Shi (JP); Akira SHINBO, Shiojiri-Shi (JP)

(21) Appl. No.: 18/393,831

(22) Filed: Dec. 22, 2023

(30) Foreign Application Priority Data
Dec. 26, 2022 (JP) 2022-208142

(51) Int. Cl. G03B 21/20

(52) U.S. Cl. CPC G03B 21/2073; G03B 21/208

(57) ABSTRACT

A projector includes a light source, a lens group that parallelizes the beam output from the light source, a light-incident-side polarizer that transmits the beam having exited out of the lens group, a light modulator that modulates the beam having passed through the light-incident-side polarizer to form a projection image, a light-exiting-side polarizer that transmits the beam modulated by the light modulator, and a projection lens that projects the beam having passed through the light-exiting-side polarizer. The light modulator includes first sub-pixels on which blue light is incident, second sub-pixels on which green light is incident, and third sub-pixels on which red light is incident. The lens group includes two lenses each having positive power. The two lenses each have a convex surface.

The present application is based on, and claims priority from JP Application Serial Number 2022-208142, filed Dec. 26, 2022, the disclosure of which is hereby incorporated by reference herein in its entirety.

### BACKGROUND

### 1. Technical Field

The present disclosure relates to a projector.

### 2. Related Art

JP-A-2003-121930 describes a single-panel projector formed of a single liquid crystal panel. The single-panel projector described in JP-A-2003-121930 includes a light source, a light collecting system that collects the light radiated from the light source, a liquid crystal panel that modulates the light from the light collecting system to form an image, and a projection lens that enlarges the image generated by the liquid crystal panel and projects the enlarged image onto a screen.

JP-A-2003-121930 is an example of the related art.

In the single-panel projector described in JP-A-2003-121930, the light collecting system includes a single lens. In such a single-panel projector, a light-incident-side polarizer is disposed between the light collecting system and the liquid crystal panel. When the light collecting system is formed of a single lens, the beam incident on the lens has a circular beam distribution. However, since the transmittance of the lens that transmits the beam varies in accordance with the polarization direction of the beam incident on the lens and the angle of incidence of the beam, the beam distribution of the beam having exited out of the lens and the light-incident-side polarizer has an elliptical shape. Since the elliptical beam having passed through the light-incident-side polarizer therefore impinges on the liquid crystal panel, there is a problem of a dark peripheral portion of the projection image formed by the liquid crystal panel.

### SUMMARY

To solve the problem described above, a projector according to an aspect of the present disclosure includes a light source, a lens group that parallelizes a beam output from the light source, a light-incident-side polarizer that transmits the beam that exits out of the lens group, a light modulator that modulates the beam passing through the light-incident-side polarizer to form a projection image, a light-exiting-side polarizer that transmits the beam modulated by the light modulator, and a projection lens that projects the beam passing through the light-exiting-side polarizer. The light modulator includes first sub-pixels on which blue light is incident, second sub-pixels on which green light is incident, and third sub-pixels on which red light is incident. The lens group includes two lenses each having positive power, and the two lenses each have a convex surface.

### BRIEF DESCRIPTION OF THE DRAWINGS

FIG. 1 is a schematic view of key parts of a projector according to Embodiment 1.

FIG. 2 is a schematic view showing pixels of a liquid crystal panel.

FIG. 3 shows the relationship between the angle of incidence and transmittance.

FIG. 4 describes the shape of the distribution of a beam containing a light component polarized along the direction of an X-axis after the beam exits out of a lens.

FIG. 5 describes the shape of the distribution of the beam containing a light component polarized along the direction of a Y-axis after the beam exits out of the lens.

FIG. 6 is a schematic view of key parts of the projector according to Comparative Example.

FIG. 7 is a schematic view of key parts of the projector according to Embodiment 2.

FIG. 8 is a schematic view of key parts of the projector according to Embodiment 3.

FIG. 9 is a schematic view of key parts of the projector according to Embodiment 4.

FIG. 10 is a schematic view of key parts of the projector according to Embodiment 5.

FIG. 11 is a schematic view of key parts of the projector according to Embodiment 6.

FIG. 12 is a schematic view of key parts of the projector according to Embodiment 7.

FIG. 13 is a schematic view of key parts of the projector according to Embodiment 8.

FIG. 14 is a schematic view of key parts of the projector according to Embodiment 9.

FIG. 15 is a schematic view of key parts of the projector according to Embodiment 10.

FIG. 16 is an exploded perspective view of an adjustment mechanism.

### DESCRIPTION OF EMBODIMENTS

Projectors according to embodiments of the present disclosure will be described below with reference to the drawings.

### Embodiment 1

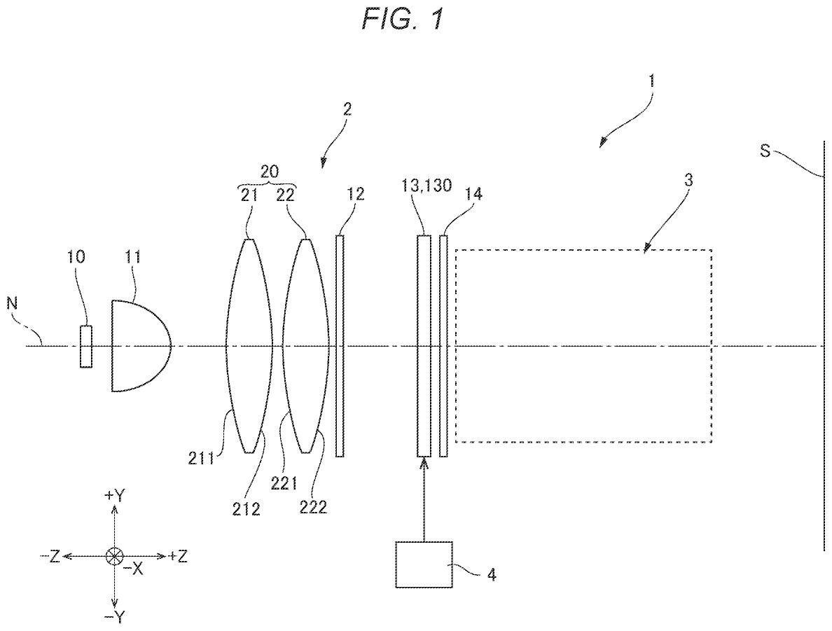

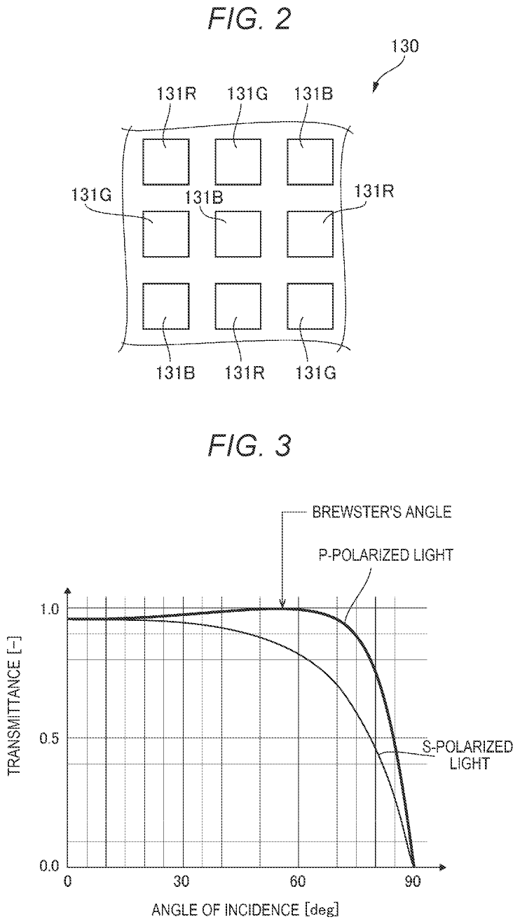

FIG. 1 is a schematic view of key parts of the projector according to Embodiment 1. FIG. 2 is a schematic view showing pixels of a liquid crystal panel. A projector 1 includes an image formation unit 2, which generates a projection image to be projected onto a screen S, a projection lens 3, which enlarges the projection image and projects the enlarged projection image onto the screen S, and a controller 4, which controls the operation of the image formation unit 2, as shown in FIG. 1.

The image formation unit 2 includes a light source 10, a pickup lens 11, a lens group 20, a light-incident-side polarizer 12, a light modulator 13, and a light-exiting-side polarizer 14. The light source 10, the pickup lens 11, the lens group 20, the light-incident-side polarizer 12, the light modulator 13, and the light-exiting-side polarizer 14 are arranged along an optical axis N. The light source 10 is formed, for example, of an ultrahigh-pressure mercury lamp or a solid-state light source. In the present embodiment, the light source 10 is an LED that emits white randomly polarized light. The pickup lens 11 guides the beam output from the light source 10 to the lens group 20. In the following description, three axes perpendicular to one another are called an X-axis, a Y-axis, and a Z-axis for convenience. The direction which extends along the optical axis N of the lens group 20 and in which the beam from the light source 10 enters and exits out of the lens group 20 is called a direction Z toward the positive end thereof. In the present embodiment, the light component polarized along the direction of the X-axis may be referred to as X-polarized light, and the light component polarized along the direction of the Y-axis may be referred to as Y-polarized light.

The lens group 20 parallelizes the beam output from the light source 10. The light-incident-side polarizer 12 is disposed between the lens group 20 and the light modulator 13. The light incident-side polarizer 12 transmits the beam containing a light component polarized in a direction that intersects with the absorption axis of the light-incident-side polarizer 12 out of the polarized light components contained in the beam having exited out of the lens group 20. In the present embodiment, the light-incident-side polarizer 12 transmits the beam containing a light component polarized in the direction of the X-axis out of the polarized light components contained in the beam having exited out of the lens group 20.

The light modulator 13 modulates the beam containing the light component having passed through the light-incident-side polarizer 12 and polarized along the direction of the X-axis to form a projection image. The light modulator 13 is a liquid crystal panel 130. In the present embodiment, the liquid crystal panel 130 is formed of a single panel and forms a color projection image. That is, the projector 1 according to the present embodiment is a single-panel projector. The liquid crystal panel 130 includes first sub-pixels 131B, on which blue light is incident, second sub-pixels 131G, on which green light is incident, and third sub-pixels 131R, on which red light is incident, as shown in FIG. 2. A microlens array that is not shown but includes a plurality of microlenses is disposed on the light incident side of the liquid crystal panel 130. The plurality of microlenses cause color light corresponding to the sub-pixels 131B to 131R to be incident on the sub-pixels 131B to 131R. When color light corresponding to the sub-pixels 131B to 131R is incident on the sub-pixels 131B to 131R, the sub-pixels 131B to 131R modulate the corresponding color light. The liquid crystal panel 130 thus forms a color projection image.

The light-exiting-side polarizer 14 transmits the beam containing a light component polarized along one of the direction of the X-axis and the direction of the Y-axis out of the polarized light components contained in the beam output from the liquid crystal panel 130. In the present embodiment, the light-exiting-side polarizer 14 transmits the beam containing the light component polarized along the direction of the Y-axis out of the polarized light components contained in the beam output from the liquid crystal panel 130.

The projection lens 3 projects the beam having passed through the light-exiting-side polarizer 14 onto the screen S. The projection lens 3 includes a plurality of lenses. The controller 4 operates the liquid crystal panel 130 based on an external image signal, such as a video signal.

### Lens Group

The lens group 20 includes a plurality of lenses. In the present embodiment, the lens group 20 includes two lenses. The two lenses include a first lens 21 disposed at the side facing the light source 10, and a second lens 22 disposed at a position shifted from the first lens 21 toward the liquid crystal panel 130.

The first lens 21 is made of resin. The first lens 21 has positive power. The first lens 21 has a first lens surface 211, which faces the light source 10, and a second lens surface 212, which faces the liquid crystal panel 130. The first lens surface 211 and the second lens surface 212 each have a convex shape. Note that an antireflection film may be provided at each of the first lens surface 211 and the second lens surface 212.

The second lens 22 has a third lens surface 221 facing the light source 10, and a fourth lens surface 222 facing the liquid crystal panel 130. The third lens surface 221 and the fourth lens surface 222 each have a convex shape. An antireflection film may be provided at each of the third lens surface 221 and the fourth lens surface 222.

### Characteristics of Lens

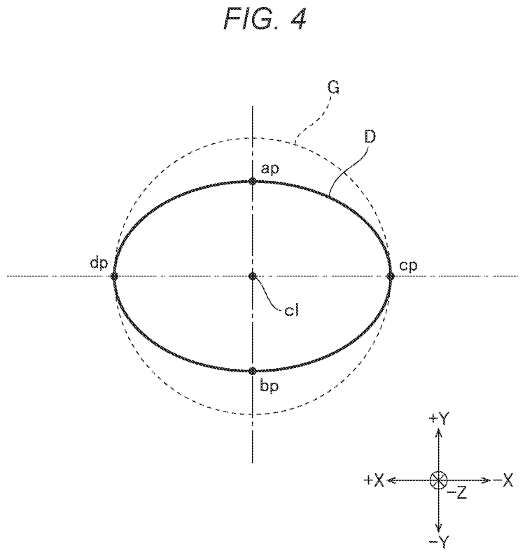

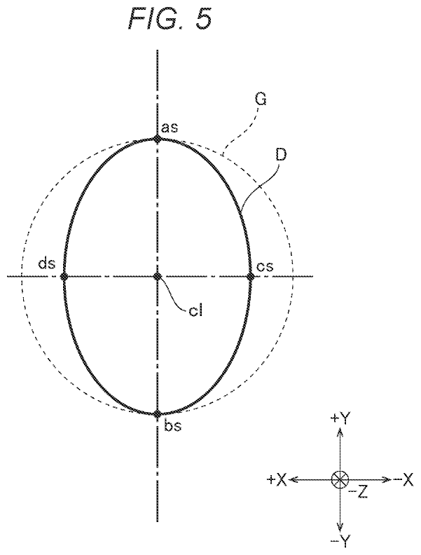

The characteristics of a lens will be described. FIG. 3 shows the relationship between the angle of incidence and transmittance. FIG. 4 describes the shape of the distribution of the beam containing the light component polarized along the direction of the X-axis after the beam enters the lens and then exits out thereof. FIG. 5 describes the shape of the distribution of the beam containing the light component polarized along the direction of the Y-axis after the beam enters the lens and then exits out thereof.

As compared with the amount of P-polarized beam passing through an optical material, the amount of S-polarized beam passing through the optical material significantly decreases as the angle of incidence of the beam increases, as shown in FIG. 3. Therefore, up to Brewster's angle, the difference between the amount of P-polarized beam and the amount of S-polarized beam increases as the angle of incidence of the beam increases. FIG. 3 shows the relationship between the angle of incidence and the transmittance of quartz glass, and the difference between the amount of P-polarized beam and the amount of S-polarized beam increases as the angle of incidence of the beam increases up to Brewster's angle irrespective of the optical material.

FIG. 4 shows how the beam passes through the lens as will be described below. The beam passing through the lens follows the P-polarization direction in the plane XY at the outer periphery of the lens on opposite sides of the direction of the X-axis, which intersects with the optical axis N of the lens. The beam passing through the lens follows the S-polarization direction in the plane XY at the outer periphery of the lens on opposite sides of the direction of the Y-axis, which intersects with the optical axis N of the lens. Therefore, in the case of the X-polarized light, the difference between the amount of P-polarized beam passing through the outer periphery of the lens on opposite sides of the direction of the X-axis, which intersects with the optical axis N of the lens, and the amount of S-polarized beam passing through the outer periphery of the lens on opposite sides of the direction of the Y-axis, which intersects with the optical axis N of the lens, increases as the angle of incidence of the beam increases. As a result, when the positive power of the lens increases, the angle of incidence of the beam passing through the outer periphery of the lens also increases, so that the distribution of the beam having exited out of the lens and containing the light component polarized along the direction of the X-axis changes from a circular shape G to an elliptical shape D, as shown in FIG. 4.

FIG. 5 shows how the beam passes through the lens as will be described below. The beam passing through the lens follows the P-polarization direction in the plane XY at the outer periphery of the lens on opposite sides of the direction of the Y-axis, which intersects with the optical axis N of the lens. The beam passing through the lens follows the S-polarization direction in the plane XY at the outer periphery of the lens on opposite sides of the direction of the X-axis, which intersects with the optical axis N of the lens. Therefore, in the case of the Y-polarized light, the difference between the amount of P-polarized beam passing through the outer periphery of the lens on opposite sides of the direction of the Y-axis, which intersects with the optical axis N of the lens, and the amount of S-polarized beam passing through the outer periphery of the lens on opposite sides of the direction of the X-axis, which intersects with the optical axis N of the lens, increases as the angle of incidence of the beam increases. As a result, when the positive power of the lens increases, the angle of incidence of the beam passing through the outer periphery of the lens also increases, so that the distribution of the beam contained in the beam having exited out of the lens and containing the light component polarized along the direction of the Y-axis changes from the circular shape G to the elliptical shape D, as shown in FIG. 5.

There are three-panel projectors using three liquid crystal panels to form a projection image. The liquid crystal panel used in a single-panel projector uses the single liquid crystal panel for color display, and therefore has a larger effective display area and in turn a greater lens effective diameter of the lens group disposed at the light incident side of the liquid crystal panel than the liquid crystal panels used in a three-panel projector. It is desirable in a single-panel projector to reduce the distance between the light source and the lens group from the viewpoint of size reduction. Therefore, in a single-panel projector, the angle of incidence of the beam incident on the lens group tends to be large, so that the distribution of the X-polarized or Y-polarized beam having exited out of the lens group tends to change to an elliptical shape.

### Lens Evaluation Formula

Based on the characteristics of a lens, the beam distribution of the beam having exited out of the lens can be evaluated by the following evaluation formula:

$$E = 1 / ( 4 Imax ) \times ( \vert Iap - Ias \vert + \vert Ibp - Ibs \vert + \vert Icp - Ics \vert + \vert Idp - Ids \vert ) \qquad ( 1 )$$

The evaluation value E calculated by the evaluation formula (1) described above is a value indicating how much the circular distribution of the beam incident on the lens changes, when the beam exits out of the lens, in an evaluation plane set at a fixed position separate from the light source. According to the evaluation formula (1), the smaller the difference in the amount of light passing through the lens between the X-polarized light and the Y-polarized light, the smaller the evaluation value E. That is, the smaller the evaluation value E, the closer the distribution of the beam having exited out of the lens to a circular shape, whereas the greater the evaluation value E, the closer the distribution of the beam having exited out of the lens to an elliptical shape.

In the evaluation formula (1) described above, Imax represents the illuminance of each of the P-polarized light and the S-polarized light at a center position cl in FIGS. 4 and 5, and the illuminance of the polarized light component along the direction of the X-axis (X-polarized light) and the illuminance of the polarized light component along the direction of the Y-axis (Y-polarized light) have the same value. Iap represents the illuminance of the X-polarized light at a boundary position ap on the minor axis (facing positive end of Y-axis) in FIG. 4. Ibp represents the illuminance of the X-polarized light at a boundary position bp on the minor axis (facing negative end of Y-axis) in FIG. 4. Icp represents the illuminance of the X-polarized light at a boundary position cp on the major axis (facing negative end of X-axis) in FIG. 4. Idp represents the illuminance of the X-polarized light at a boundary position dp on the major axis (facing positive end of X-axis) in FIG. 4. Ias represents the illuminance of the Y-polarized light at a boundary position as on the major axis (facing positive end of Y-axis) in FIG. 5. Ibs represents the illuminance of the Y-polarized light at a boundary position bs on the major axis (facing negative end of Y-axis) in FIG. 5. Ics represents the illuminance of the Y-polarized light at a boundary position cs on the minor axis (facing negative end of X-axis) in FIG. 5. Ids represents the illuminance of the Y-polarized light at a boundary position ds on the minor axis (facing positive end of X-axis) in FIG. 5. Note that the distances from the boundary positions ap, bp, as, and bs to the center position cl are equal to each other. Further note that the distances from the boundary positions cp, dp, cs, and ds to the center position cl are equal to each other.

### Comparison Between Embodiment 1 and Comparative Example

The beam distribution of the beam having exited out of the lens group 20 in the projector 1 according to Embodiment 1 and the beam distribution of the beam having exited out of a lens in a projector according to Comparative Example were compared with each other by using the evaluation formula (1) described above. The variety of kinds of illuminance used in the evaluation formula (1) were each calculated by using simulation software. LightTools available from Synopsys, Inc. was used as the simulation software.

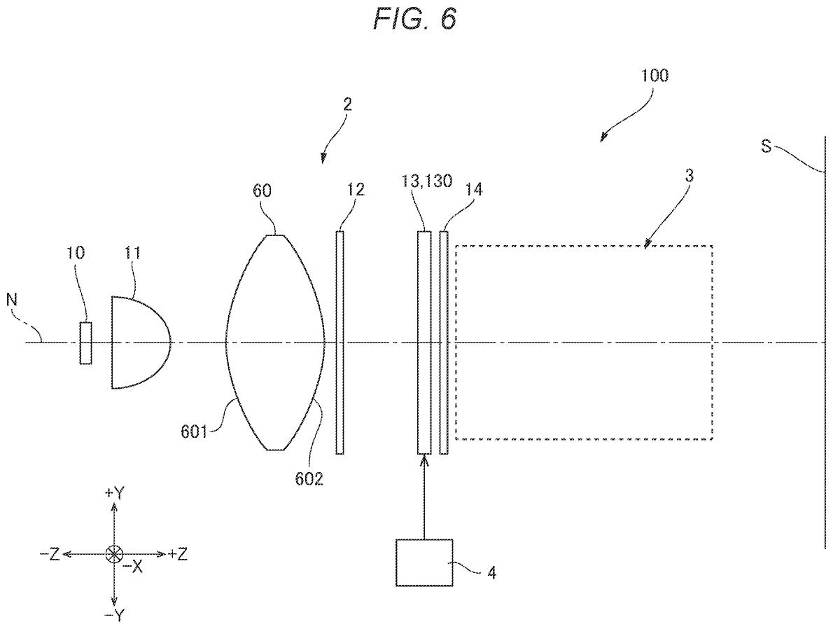

FIG. 6 is a schematic view of key parts of a projector 100 according to Comparative Example. The projector 100 according to Comparative Example differs from the projector 1 according to Embodiment 1 in that one lens 60 is provided. Therefore, in Comparative Example, the same configurations as those in Embodiment 1 have the same reference characters, and no description of the same configurations will be made in some cases. The lens 60 has positive power. A first lens surface 601 of the lens 60 has a convex shape, as shown in FIG. 6. A second lens surface 602 of the lens 60 has a convex shape.

As a procedure for comparing Embodiment 1 with Comparative Example, the illuminance corresponding to each position in the beam distribution of the beam having exited out of the second lens 22 of the lens group 20 in Embodiments 1-1 to 1-3, and the illuminance corresponding to each position in the beam distribution of the beam having exited out of the lens 60 in Comparative Example were each determined by using LightTools, followed by calculation of each evaluation value E by using the evaluation formula (1), and comparison among the evaluation values E.

Lens data on each of the lenses in Embodiment 1 set by LightTools are shown below. Reference character R represents the absolute value of the radius of curvature. Reference character D represents the axial inter-surface spacing. Reference character nd represents the refractive index.

| | | |
|---|---|---|
| R | D | nd |

Embodiment 1-1

| | | | | |
|---|---|---|---|---|
| Light source | | | 60 mm | |
| First lens | First lens surface | 99 mm | 22 mm | 1.4936 |
| | Second lens surface | 99 mm | 4 mm | |
| Second lens | Third lens surface | 300 mm | 22 mm | 1.4936 |
| | Fourth lens surface | 300 mm | 2 mm | |
| Evaluation plane | Evaluation plane | ∞ | — | — |

Embodiment 1-2

| | | | | |
|---|---|---|---|---|
| Light source | | | 60 mm | |
| First lens | First lens surface | 145 mm | 22 mm | 1.4936 |
| | Second lens surface | 145 mm | 4 mm | |
| Second lens | Third lens surface | 145 mm | 22 mm | 1.4936 |
| | Fourth lens surface | 145 mm | 2 mm | |
| Evaluation plane | Evaluation plane | ∞ | — | — |

Embodiment 1-3

| | | | | |
|---|---|---|---|---|
| Light source | | | 60 mm | |
| First lens | First lens surface | 300 mm | 22 mm | 1.4936 |
| | Second lens surface | 300 mm | 4 mm | |
| Second lens | Third lens surface | 99 mm | 22 mm | 1.4936 |
| | Fourth lens surface | 99 mm | 2 mm | |
| Evaluation plane | Evaluation plane | ∞ | — | — |

Data on the focal length of each of the lenses in Embodiment 1 set by LightTools are shown below. Reference character f1 represents the focal length of the first lens 21. Reference character f2 represents the focal length of the second lens 22. Reference character f represents the combined focal length of the first lens 21 and the second lens 22.

| | Embodiment 1-1 | Embodiment 1-2 | Embodiment 1-3 |
|---|---|---|---|
| f1 | 100.28 mm | 146.88 mm | 303.89 mm |
| f2 | 303.89 mm | 146.88 mm | 100.28 mm |
| f | 80.6 mm | 80.6 mm | 80.6 mm |

Lens data on the lens in Comparative Example set by LightTools are shown below. Reference character R represents the absolute value of the radius of curvature. Reference character D represents the axial inter-surface spacing. Reference character nd represents the refractive index.

### Comparative Example

| | | R | D | nd |
|---|---|---|---|---|
| Light source | | | 61 mm | |
| Lens | First lens surface | 79 mm | 48 mm | 1.4936 |
| | Second lens surface | 79 mm | 1 mm | |
| Evaluation plane | Evaluation plane | ∞ | — | — |

Data on the focal length of the lens in Comparative Example set by LightTools are shown below. Reference character f0 represents the focal length of the lens 60.

### Comparative Example

f0 80.0 mm

The tables below show illuminance corresponding to each position in the beam distribution of the beam having exited out of the second lens 22 of the lens group 20 in Embodiments 1-1 to 1-3 and illuminance corresponding to each position in the beam distribution of the beam having exited out of the lens 60 in Comparative Example at the evaluation plane set by LightTools. Note that the evaluation plane is set at the same position in Embodiments 1-1 to 1-3 and Comparative Example.

| | Imax | Iap | Ibp | Icp | Idp |
|---|---|---|---|---|---|
| Embodiment 1-1 | 10.3651 | 8.88411 | 8.86885 | 8.94975 | 8.93710 |
| Embodiment 1-2 | 9.58675 | 7.40148 | 7.37722 | 7.67853 | 7.61593 |
| Embodiment 1-3 | 8.73107 | 6.58396 | 6.57536 | 7.14871 | 7.13889 |
| Comparative | 9.01271 | 8.10002 | 8.10153 | 9.33797 | 9.36489 |
| Example | | | | | |

| | Ias | Ibs | Ics | Ids |
|---|---|---|---|---|
| Embodiment 1-1 | 8.94498 | 8.92962 | 8.88885 | 8.87629 |
| Embodiment 1-2 | 7.64815 | 7.62309 | 7.43087 | 7.37030 |
| Embodiment 1-3 | 7.16189 | 7.15255 | 6.57190 | 6.56293 |
| Comparative | 9.35453 | 9.35640 | 8.08559 | 8.10883 |
| Example | | | | |

The evaluation values E of the lenses in Embodiments 1-1 to 1-3 and Comparative Example are shown below.

| | E |
|---|---|
| Embodiment 1-1 | 0.00587 |
| Embodiment 1-2 | 0.02571 |
| Embodiment 1-3 | 0.06608 |
| Comparative | 0.13919 |
| Example | |

The evaluation values E in Embodiments 1-1 to 1-3 are smaller than the evaluation value E in Comparative Example, as shown above. Therefore, when the focal length f of the lens group 20 in Embodiments 1-1 to 1-3 and the focal length f0 of the lens 60 in Comparative Example are set at the same value, the lens power of each of the lenses in Embodiments 1-1 to 1-3 is smaller than the lens power of the lens 60 in Comparative Example, and it is therefore found that the beam distribution of the beam having exited out of the second lens 22 of the lens group 20 in Embodiments 1-1 to 1-3 is smaller in terms of the amount of change in the shape of the beam distribution than the beam distribution of the beam having exited out of the lens 60 in Comparative Example. That is, the beam distribution of the beam having exited out of the second lens 22 of the lens group 20 in Embodiments 1-1 to 1-3 is closer to a circular shape than the beam distribution of the beam having exited out of the lens 60 in Comparative Example.

The beam distribution of the beam having exited out of the second lens 22 of the lens group 20 in Embodiment 1-1 out of Embodiment 1-1 to 1-3 is closest to a circular shape. That is, when the focal length of the first lens 21 is shorter than the focal length of the second lens 22, the beam distribution of the beam having exited out of the lens group 20 is closest to a circular shape.

Furthermore, the lenses in Embodiments 1-1 to 1-3 can each be thinner than the lens 60 in Comparative Example.

### Effects and Advantages

The projector 1 according to the present embodiment includes the light source 10, the lens group 20, which parallelizes the beam output from the light source 10, the light-incident-side polarizer 12, which transmits the beam having exited out of the lens group 20, the liquid crystal panel 130, which modulates the beam having passed through the light-incident-side polarizer 12 to form a projection image, the light-exiting-side polarizer 14, which transmits the beam modulated by the liquid crystal panel 130, and the projection lens 3, which projects the beam having passed through the light-exiting-side polarizer 14. The liquid crystal panel 130 includes the first sub-pixels 131B, on which blue light is incident, the second sub-pixels 131G, on which green light is incident, and the third sub-pixels 131R, on which red light is incident. The lens group 20 includes two lenses each having positive power. The two lenses include the first lens 21 disposed at the side facing the light source 10, and the second lens 22 disposed at a position shifted from the first lens 21 toward the liquid crystal panel 130. The first lens 21 and the second lens 22 each have convex surfaces.

In the present embodiment, the number of liquid crystal panels 130 is one. That is, the projector 1 according to the present embodiment is a single-panel projector. Since the liquid crystal panel in a single-panel projector has a plurality of sub-pixels, the effective display area of the liquid crystal panel is larger than that of each of the liquid crystal panels of a three-panel projector. An increase in the size of the liquid crystal panel then increases the effective diameter of the lens disposed at the light incident side of the liquid crystal panel. As a result, the angle of incidence of the beam incident on the lens tends to be large, so that the beam distribution of the light component contained in the beam having exited out of the lens and polarized along the direction of the X-axis or the Y-axis tends to change to an elliptical shape.

Single-panel projectors, when compared with 3-panel projectors especially from the viewpoint of size reduction, have a risk of a significant increase in the distance between the light source and the liquid crystal panel in an attempt to dispose a dividing and superimposing optical system between the light source and the liquid crystal panel. It is therefore difficult to precisely homogenize the beam having exited out of the lens disposed at the light incident side of the liquid crystal panel by using the dividing and superimposing optical system while attempting to reduce the size of a single-panel projector. Therefore, when the beam distribution of the light component contained in the beam having exited out of the lens and polarized along the direction of the X-axis or the Y-axis changes to an elliptical shape, the elliptical beam impinges on the liquid crystal panel. As a result, single-panel projectors tend to generate a projection image formed by the liquid crystal panel and having a dark periphery as compared with three-panel projectors.

The present embodiment, in which the lens group 20 includes two lenses, allows a decrease in the lens power of each of the lenses as compared with the case where the lens group 20 includes one lens. Since the angle of incidence of the beam incident on each of the lenses of the lens group 20 can thus be reduced, the change in the shape of the beam distribution of the beam having exited out of the second lens 22 can be reduced. As a result, the beam distribution of the beam having exited out of the lens group 20 has nearly a circular shape, so that the dark peripheral portion of the projection image formed by the liquid crystal panel 130 can be suppressed. The projector 1 can therefore project an enlarged image having uniform brightness.

Since the angle of incidence of the beam incident on each of the lenses of the lens group 20 can be reduced, a high-performance antireflection film can, for example, be provided at the lens surfaces of each of the lenses. Furthermore, since the angle of incidence of the beam incident on each of the lenses of the lens group 20 decreases, the assembly of the lenses of the lens group 20 into the enclosure of the projector 1 and adjustment of the lenses of the lens group 20 are readily performed as compared with the case where the angle of incidence of the beam is large. The production cost of the projector 1 can thus be suppressed.

The present embodiment, in which the lenses are each thinner than in the case where only one lens is provided, allows improvement in the transmittance of the beam at each of the lenses of the lens group 20. The lens group 20 can thus output a bright beam as a whole. Furthermore, since the thickness of each of the lenses of the lens group 20 can be reduced, deterioration in the optical performance of the lens group 20 due to thermal expansion of the lenses can be suppressed.

In the present embodiment, the first lens 21 includes the first lens surface 211 facing the light source 10, and the second lens surface 212 facing the liquid crystal panel 130. The second lens 22 has the third lens surface 221 facing the light source 10, and the fourth lens surface 222 facing the liquid crystal panel 130. The first lens surface 211, the second lens surface 212, the third lens surface 221, and the fourth lens surface 222 each have a convex shape. In this case, the first lens surface 211, the second lens surface 212, the third lens surface 221, and the fourth lens surface 222 can have the same absolute value of the radius of curvature. The first lens 21 and the second lens 22 thus have the same shape, so that the production cost of the lenses can be suppressed as compared with a case where the first lens 21 and the second lens 22 have different shapes. Since the first lens 21 and the second lens 22 have the same shape, a situation in which the first lens 21 and the second lens 22 are mistakenly swapped in the assembly of the projector 1 can be avoided.

In the present embodiment, the focal length f1 of the first lens 21 is shorter than the focal length f2 of the second lens 22. The change in the shape of the beam distribution of the beam having exited out of the second lens 22 can thus be further reduced.

In the present embodiment, the first lens 21 and the second lens 22 are made of resin. The production cost of the first lens 21 and the second lens 22 can therefore be suppressed as compared with a case where the lenses are made of glass.

### Embodiment 2

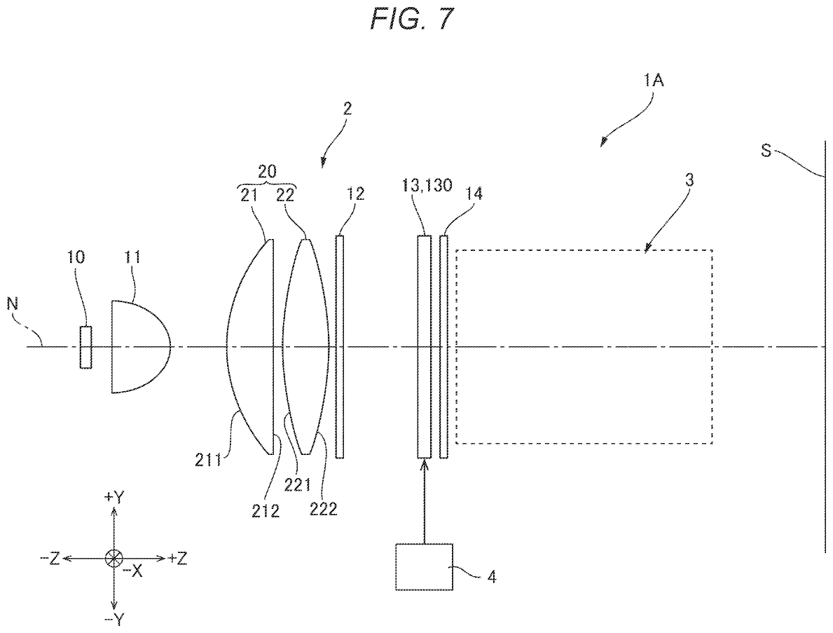

FIG. 7 is a schematic view of key parts of a projector 1A according to Embodiment 2. The projector 1A according to Embodiment 2 differs from the projector 1 according to Embodiment 1 in terms of the shape of the first lens 21 of the lens group 20. Therefore, in Embodiment 2, the same configurations as those in Embodiment 1 have the same reference characters, and no description of the same configurations will be made in some cases.

The lens group 20 includes a plurality of lenses, as shown in FIG. 7. In the present embodiment, the lens group 20 includes two lenses. The two lenses include the first lens 21 disposed at the side facing the light source 10, and the second lens 22 disposed at a position shifted from the first lens 21 toward the liquid crystal panel 130.

The first lens 21 is made of resin. The first lens 21 has positive power. The first lens 21 has the first lens surface 211 facing the light source 10, and the second lens surface 212 facing the liquid crystal panel 130. The first lens surface 211 has a convex shape. The second lens surface 212 has a planar shape. That is, the absolute value of the radius of curvature of the second lens surface 212, which is one of the first lens surface 211 and the second lens surface 212, is greater than the absolute value of the radius of curvature of the first lens surface 211, which is the other lens surface. Note that an antireflection film may be provided at each of the first lens surface 211 and the second lens surface 212.

The second lens 22 has the third lens surface 221 facing the light source 10, and the fourth lens surface 222 facing the liquid crystal panel 130. The third lens surface 221 and the fourth lens surface 222 each have a convex shape. An antireflection film may be provided at each of the third lens surface 221 and the fourth lens surface 222.

### Comparison Between Embodiment 2 and Comparative Example

The beam distribution of the beam having exited out of the lens group 20 in the projector 1A according to Embodiment 2 and the beam distribution of the beam having exited out of the lens 60 in the projector 100 according to Comparative Example were compared with each other by using the evaluation formula (1) described above, as in Embodiment 1.

Lens data on each of the lenses in Embodiment 2 set by LightTools are shown below. Reference character R represents the absolute value of the radius of curvature. Reference character D represents the axial inter-surface spacing. Reference character nd represents the refractive index.

### Embodiment 2

| | | R | D | nd |
|---|---|---|---|---|
| Light source | | | 60 mm | |
| First lens | First lens surface | 72.5 mm | 22 mm | 1.4936 |
| | Second lens surface | ∞ | 4 mm | |
| Second lens | Third lens surface | 145 mm | 22 mm | 1.4936 |
| | Fourth lens surface | 145 mm | 2 mm | |
| Evaluation plane | Evaluation plane | ∞ | — | — |

Data on the focal length of each of the lenses in Embodiment 2 set by LightTools are shown n below. Reference character f1 represents the focal length of the first lens 21. Reference character f2 represents the focal length of the second lens 22. Reference character f represents the combined focal length of the first lens 21 and the second lens 22.

### Embodiment 2

| | |
|---|---|
| f1 | 146.88 mm |
| f2 | 146.88 mm |
| f | 80.6 mm |

Lens data on the lens in Comparative Example set by LightTools are shown below. Reference character R represents the absolute value of the radius of curvature. Reference character D represents the axial inter-surface spacing. Reference character nd represents the refractive index.

### Comparative Example

| | | R | D | nd |
|---|---|---|---|---|
| Light source | | | 61 mm | |
| Lens | First lens surface | 79 mm | 48 mm | 1.4936 |
| | Second lens surface | 79 mm | 1 mm | |
| Evaluation plane | Evaluation plane | ∞ | — | — |

Data on the focal length of the lens in Comparative Example set by LightTools are shown below. Reference character f0 represents the focal length of the lens 60.

### Comparative Example

f0 80.0 mm

The tables below show illuminance corresponding to each position in the beam distribution of the beam having exited out of the second lens 22 of the lens group 20 in Embodiment 2 and illuminance corresponding to each position in the beam distribution of the beam having exited out of the lens 60 in Comparative Example at the evaluation plane set by LightTools. Note that the evaluation plane is set at the same position in Embodiment 2 and Comparative Example.

| | Imax | Iap | Ibp | Icp | Idp |
|---|---|---|---|---|---|
| Embodiment 2 | 10.0967 | 8.42838 | 8.43131 | 8.69414 | 8.72037 |
| Comparative | 9.01271 | 8.10002 | 8.10153 | 9.33797 | 9.36489 |
| Example | | | | | |

| | Ias | Ibs | Ics | Ids |
|---|---|---|---|---|
| Embodiment 2 | 8.70827 | 8.71128 | 8.41471 | 8.44011 |
| Comparative | 9.35453 | 9.35640 | 8.08559 | 8.10883 |
| Example | | | | |

The evaluation values E of the lenses in Embodiment 2 and Comparative Example are shown below.

| | E |
|---|---|
| Embodiment 2 | 0.02772 |
| Comparative | 0.13919 |
| Example | |

The evaluation value E in Embodiment 2 is smaller than the evaluation value E in Comparative Example, as shown above. Therefore, when the focal length f of the lens group 20 in Embodiment 2 and the focal length f0 of the lens 60 in Comparative Example are set at the same value, the lens power of each of the lenses in Embodiment 2 is smaller than the lens power of the lens 60 in Comparative Example, and it is therefore found that the beam distribution of the beam having exited out of the second lens 22 of the lens group 20 in Embodiment 2 is smaller in distribution than the beam distribution of the beam having exited out of the lens 60 in Comparative Example. That is, the beam distribution of the beam having exited out of the second lens 22 of the lens group 20 in Embodiment 2 is closer to a circular shape than the beam distribution of the beam having exited out of the lens 60 in Comparative Example.

Furthermore, the lenses in Embodiment 2 can each be thinner than the lens 60 in Comparative Example.

### Effects and Advantages

In the projector 1A according to the present embodiment, the first lens surface 211 has a convex shape. The second lens surface 212 has a planar shape. The third lens surface 221 and the fourth lens surface 222 each have a convex shape. Out of the first lens surface 211 and the second lens surface 212, the absolute value of the radius of curvature of the second lens surface 212 is greater than the absolute value of the radius of curvature of the first lens surface 211. The thus configured projector 1A according to the present embodiment, in which the lens group 20 includes two lenses, can provide the same effects as those provided by Embodiment 1.

### Embodiment 3

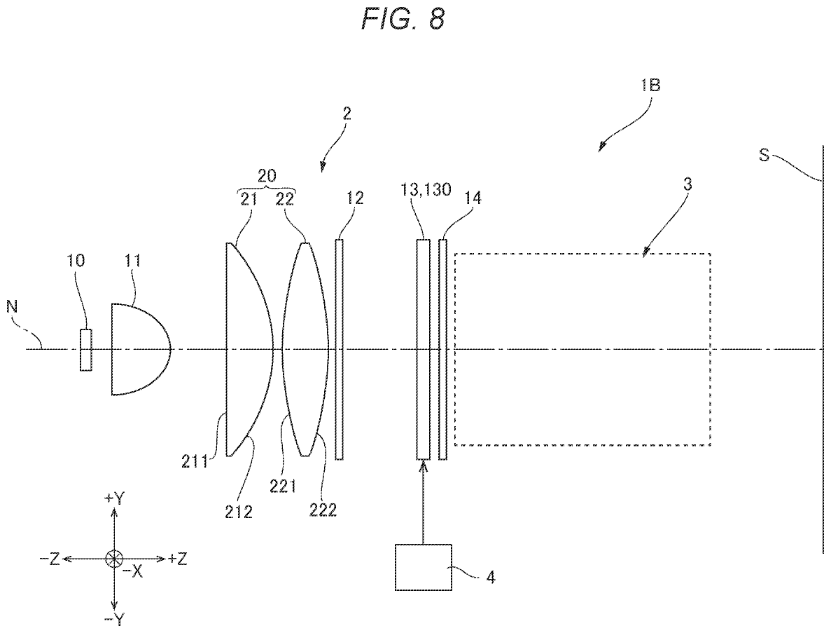

FIG. 8 is a schematic view of key parts of a projector 1B according to Embodiment 3. The projector 1B according to Embodiment 3 differs from the projector 1 according to Embodiment 1 in terms of the shape of the first lens 21 of the lens group 20. Therefore, in Embodiment 3, the same configurations as those in Embodiment 1 have the same reference characters, and no description of the same configurations will be made in some cases.

The lens group 20 includes a plurality of lenses, as shown in FIG. 8. In the present embodiment, the lens group 20 includes two lenses. The two lenses include the first lens 21 disposed at the side facing the light source 10, and the second lens 22 disposed at a position shifted from the first lens 21 toward the liquid crystal panel 130.

The first lens 21 is made of resin. The first lens 21 has positive power. The first lens 21 has the first lens surface 211 facing the light source 10, and the second lens surface 212 facing the liquid crystal panel 130. The first lens surface 211 has a planar shape. The second lens surface 212 has a convex shape. That is, the absolute value of the radius of curvature of the first lens surface 211, which is one of the first lens surface 211 and the second lens surface 212, is greater than the absolute value of the radius of curvature of the second lens surface 212, which is the other lens surface. Note that an antireflection film may be provided at each of the first lens surface 211 and the second lens surface 212.

The second lens 22 has the third lens surface 221 facing the light source 10, and the fourth lens surface 222 facing the liquid crystal panel 130. The third lens surface 221 and the fourth lens surface 222 each have a convex shape. An antireflection film may be provided at each of the third lens surface 221 and the fourth lens surface 222.

### Comparison Between Embodiment 3 and Comparative Example

The beam distribution of the beam having exited out of the lens group 20 in the projector 1B according to Embodiment 3 and the beam distribution of the beam having exited out of the lens 60 in the projector 100 according to Comparative Example were compared with each other by using the evaluation formula (1) described above, as in Embodiment 1.

Lens data on each of the lenses in Embodiment 3 set by LightTools are shown below. Reference character R represents the absolute value of the radius of curvature. Reference character D represents the axial inter-surface spacing. Reference character nd represents the refractive index.

### Embodiment 3

| | | R | D | nd |
|---|---|---|---|---|
| Light source | | | 60 mm | |
| First lens | First lens surface | ∞ mm | 22 mm | 1.4936 |
| | Second lens surface | 72.5 mm | 4 mm | |
| Second lens | Third lens surface | 145 mm | 22 mm | 1.4936 |
| | Fourth lens surface | 145 mm | 2 mm | |
| Evaluation plane | Evaluation plane | ∞ | — | — |

Data on the focal length of each of the lenses in Embodiment 3 set by LightTools are shown below. Reference character f1 represents the focal length of the first lens 21. Reference character f2 represents the focal length of the second lens 22. Reference character f represents the combined focal length of the first lens 21 and the second lens 22.

### Embodiment 3

| | |
|---|---|
| f1 | 146.88 mm |
| f2 | 146.88 mm |
| f | 80.6 mm |

Lens data on the lens in Comparative Example set by LightTools are shown below. Reference character R represents the absolute value of the radius of curvature. Reference character D represents the axial inter-surface spacing. Reference character nd represents the refractive index.

| | | R | D | nd |
|---|---|---|---|---|
| Light source | | | 61 mm | |
| Lens | First lens surface | 79 mm | 48 mm | 1.4936 |
| | Second lens surface | 79 mm | 1 mm | |
| Evaluation plane | Evaluation plane | ∞ | — | — |

Data on the focal length of the lens in Comparative Example set by LightTools are shown below. Reference character f0 represents the focal length of the lens 60.

### Comparative Example

f0 80.0 mm

The tables below show illuminance corresponding to each position in the beam distribution of the beam having exited out of the second lens 22 of the lens group 20 in Embodiment 3 and illuminance corresponding to each position in the beam distribution of the beam having exited out of the lens 60 in Comparative Example at the evaluation plane set by LightTools. Note that the evaluation plane is set at the same position in Embodiment 3 and Comparative Example.

| | Imax | Iap | Ibp | Icp | Idp |
|---|---|---|---|---|---|
| Embodiment 3 | 9.23940 | 7.38840 | 7.36703 | 7.63246 | 7.62177 |
| Comparative | 9.01271 | 8.10002 | 8.10153 | 9.33797 | 9.36489 |
| Example | | | | | |

| | Ias | Ibs | Ics | Ids |
|---|---|---|---|---|
| Embodiment 3 | 7.63443 | 7.61236 | 7.38649 | 7.37616 |
| Comparative | 9.35453 | 9.35640 | 8.08559 | 8.10883 |
| Example | | | | |

The evaluation values E of the lenses in Embodiment 3 and Comparative Example are shown below.

| | E |
|---|---|
| Embodiment 3 | 0.02660 |
| Comparative | 0.13919 |
| Example | |

The evaluation value E in Embodiment 3 is smaller than the evaluation value E in Comparative Example, as shown above. Therefore, when the focal length f of the lens group 20 in Embodiment 3 and the focal length f0 of the lens 60 in Comparative Example are set at the same value, the lens power of each of the lenses in Embodiment 3 is smaller than the lens power of the lens 60 in Comparative Example, and it is therefore found that the beam distribution of the beam having exited out of the second lens 22 of the lens group 20 in Embodiment 3 is smaller in terms of the amount of change in the shape of the beam distribution than the beam distribution of the beam having exited out of the lens 60 in Comparative Example. That is, the beam distribution of the beam having exited out of the second lens 22 of the lens group 20 in Embodiment 3 is closer to a circular shape than the beam distribution of the beam having exited out of the lens 60 in Comparative Example.

Furthermore, the lenses in Embodiment 3 can each be thinner than the lens 60 in Comparative Example.

### Effects and Advantages

In the projector 1B according to the present embodiment, the first lens surface 211 has a planar shape. The second lens surface 212 has a convex shape. The third lens surface 221 and the fourth lens surface 222 each have a convex shape. Out of the first lens surface 211 and the second lens surface 212, the absolute value of the radius of curvature of the first lens surface 211 is greater than the absolute value of the radius of curvature of the second lens surface 212. The thus configured projector 1B according to the present embodiment, in which the lens group 20 includes two lenses, can provide the same effects as those provided by Embodiment 1.

### Embodiment 4

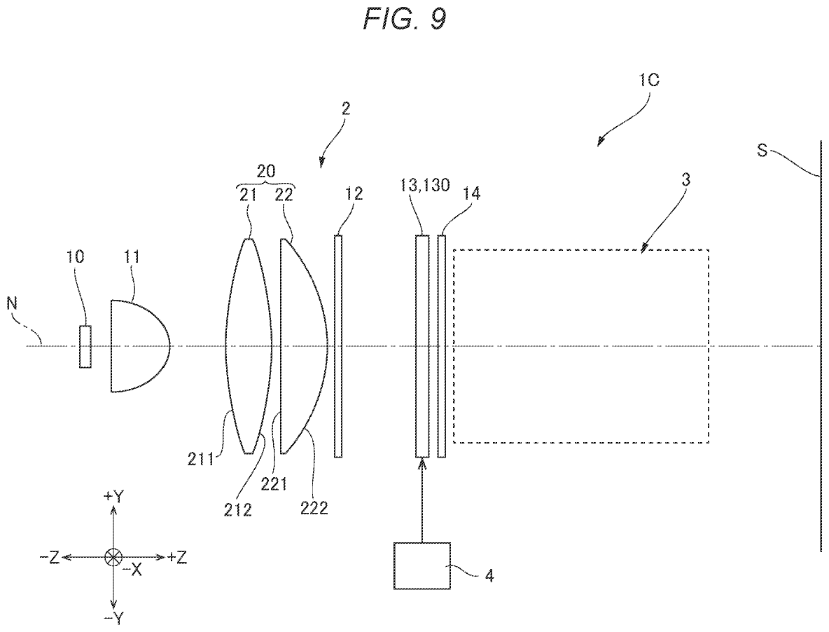

FIG. 9 is a schematic view of key parts of a projector 1C according to Embodiment 4. The projector 1C according to Embodiment 4 differs from the projector 1 according to Embodiment 1 in terms of the shape of the second lens 22 of the lens group 20. Therefore, in Embodiment 4, the same configurations as those in Embodiment 1 have the same reference characters, and no description of the same configurations will be made in some cases.

The lens group 20 includes a plurality of lenses, as shown in FIG. 9. In the present embodiment, the lens group 20 includes two lenses. The two lenses include the first lens 21 disposed at the side facing the light source 10, and the second lens 22 disposed at a position shifted from the first lens 21 toward the liquid crystal panel 130.

The first lens 21 is made of resin. The first lens 21 has positive power. The first lens 21 has the first lens surface 211 facing the light source 10, and the second lens surface 212 facing the liquid crystal panel 130. The first lens surface 211 and the second lens surface 212 each have a convex shape. Note that an antireflection film may be provided at each of the first lens surface 211 and the second lens surface 212.

The second lens 22 has the third lens surface 221 facing the light source 10, and the fourth lens surface 222 facing the liquid crystal panel 130. The third lens surface 221 has a planar shape. The fourth lens surface 222 has a convex shape. That is, out of the third lens surface 221 and the fourth lens surface 222, the absolute value of the radius of curvature of the third lens surface 221, which is one of the lens surfaces, is greater than the absolute value of the radius of curvature of the fourth lens surface 222, which is the other lens surface. An antireflection film may be provided at each of the third lens surface 221 and the fourth lens surface 222.

### Comparison Between Embodiment 4 and Comparative Example

The beam distribution of the beam having exited out of the lens group 20 in the projector 1C according to Embodiment 4 and the beam distribution of the beam having exited out of the lens 60 in the projector 100 according to Comparative Example were compared with each other by using the evaluation formula (1) described above, as in Embodiment 1.

Lens data on each of the lenses in Embodiment 4 set by LightTools are shown below. Reference character R represents the absolute value of the radius of curvature. Reference character D represents the axial inter-surface spacing. Reference character nd represents the refractive index.

### Embodiment 4

| | | R | D | nd |
|---|---|---|---|---|
| Light source | | | 60 mm | |
| First lens | First lens surface | 145 mm | 22 mm | 1.4936 |
| | Second lens surface | 145 mm | 4 mm | |
| Second lens | Third lens surface | ∞ mm | 22 mm | 1.4936 |
| | Fourth lens surface | 72.5 mm | 2 mm | |
| Evaluation plane | Evaluation plane | ∞ | — | — |

Data on the focal length of each of the lenses in Embodiment 4 set by LightTools are below. Reference character f1 represents the focal length of the first lens 21. Reference character f2 represents the focal length of the second lens 22. Reference character f represents the combined focal length of the first lens 21 and the second lens 22.

### Embodiment 4

| | |
|---|---|
| f1 | 146.88 mm |
| f2 | 146.88 mm |
| f | 80.6 mm |

Lens data on the lens in Comparative Example set by LightTools are shown below. Reference character R represents the absolute value of the radius of curvature. Reference character D represents the axial inter-surface spacing. Reference character nd represents the refractive index.

### Comparative Example

| | | R | D | nd |
|---|---|---|---|---|
| Light source | | | 61 mm | |
| Lens | First lens surface | 79 mm | 48 mm | 1.4936 |
| | Second lens surface | 79 mm | 1 mm | |
| Evaluation plane | Evaluation plane | ∞ | — | — |

Data on the focal length of the lens in Comparative Example set by LightTools are shown below. Reference character f0 represents the focal length of the lens 60.

### Comparative Example

f0 80.0 mm

The tables below show illuminance corresponding to each position in the beam distribution of the beam having exited out of the second lens 22 of the lens group 20 in Embodiment 4 and illuminance corresponding to each position in the beam distribution of the beam having exited out of the lens 60 in Comparative Example at the evaluation plane set by LightTools. Note that the evaluation plane is set at the same position in Embodiment 4 and Comparative Example.

| | Imax | Iap | Ibp | Icp | Idp |
|---|---|---|---|---|---|
| Embodiment 4 | 8.76287 | 8.66862 | 8.68789 | 9.11944 | 9.12773 |
| Comparative Example | 9.01271 | 8.10002 | 8.10153 | 9.33797 | 9.36489 |

| | Ias | Ibs | Ics | Ids |
|---|---|---|---|---|
| Embodiment 4 | 9.10036 | 9.12061 | 8.68683 | 8.69472 |
| Comparative Example | 9.35453 | 9.35640 | 8.08559 | 8.10883 |

The evaluation values E of the lenses in Embodiment 4 and Comparative Example are shown below.

| | E |
|---|---|
| Embodiment 4 | 0.04936 |
| Comparative Example | 0.13919 |

The evaluation value E in Embodiment 4 is smaller than the evaluation value E in Comparative Example, as shown above. Therefore, when the focal length f of the lens group 20 in Embodiment 4 and the focal length f0 of the lens 60 in Comparative Example are set at the same value, the lens power of each of the lenses in Embodiment 4 is smaller than the lens power of the lens 60 in Comparative Example, and it is therefore found that the beam distribution of the beam having exited out of the second lens 22 of the lens group 20 in Embodiment 4 is smaller in distribution than the beam distribution of the beam having exited out of the lens 60 in Comparative Example. That is, the beam distribution of the beam having exited out of the second lens 22 of the lens group 20 in Embodiment 4 is closer to a circular shape than the beam distribution of the beam having exited out of the lens 60 in Comparative Example.

Furthermore, the lenses in Embodiment 4 can each be thinner than the lens 60 in Comparative Example.

### Effects and Advantages

In the projector 1C according to the present embodiment, the first lens surface 211 and the second lens surface 212 each have a convex shape. The third lens surface 221 has a planar shape. The fourth lens surface 222 has a convex shape. Out of the third lens surface 221 and the fourth lens surface 222, the absolute value of the radius of curvature of the third lens surface 221 is greater than the absolute value of the radius of curvature of the fourth lens surface 222. The thus configured projector 1C according to the present embodiment, in which the lens group 20 includes two lenses, can provide the same effects as those provided by Embodiment 1.

### Embodiment 5

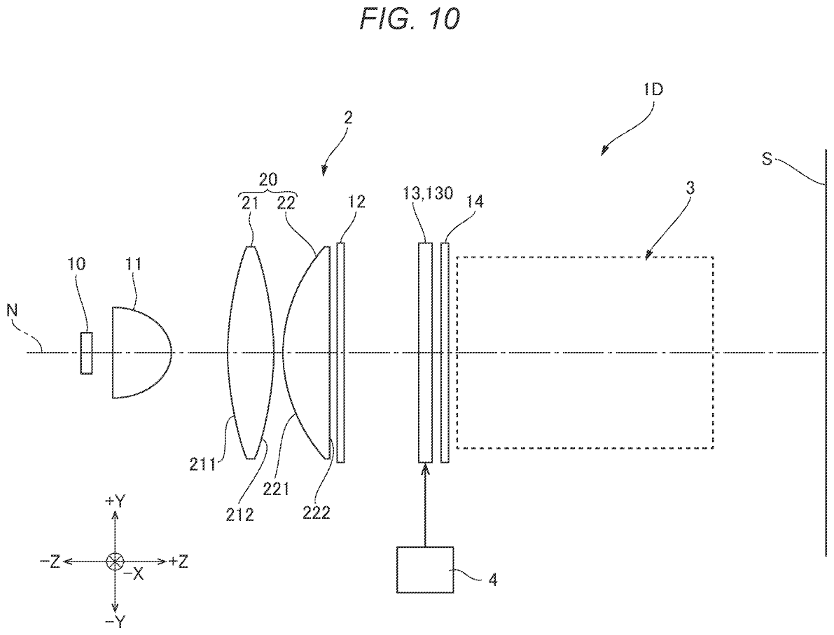

FIG. 10 is a schematic view of key parts of a projector 1D according to Embodiment 5. The projector 1D according to Embodiment 5 differs from the projector 1 according to Embodiment 1 in terms of the shape of the first lens 21 of the lens group 20. Therefore, in Embodiment 5, the same configurations as those in Embodiment 1 have the same reference characters, and no description of the same configurations will be made in some cases.

The lens group 20 includes a plurality of lenses, as shown in FIG. 10. In the present embodiment, the lens group 20 includes two lenses. The two lenses include the first lens 21 disposed at the side facing the light source 10, and the second lens 22 disposed at a position shifted from the first lens 21 toward the liquid crystal panel 130.

The first lens 21 is made of resin. The first lens 21 has positive power. The first lens 21 has the first lens surface 211 facing the light source 10, and the second lens surface 212 facing the liquid crystal panel 130. The first lens surface 211 and the second lens surface 212 each have a convex shape. Note that an antireflection film may be provided at each of the first lens surface 211 and the second lens surface 212.

The second lens 22 has the third lens surface 221 facing the light source 10, and the fourth lens surface 222 facing the liquid crystal panel 130. The third lens surface 221 has a convex shape. The fourth lens surface 222 has a planar shape. That is, out of the third lens surface 221 and the fourth lens surface 222, the absolute value of the radius of curvature of the fourth lens surface 222, which is one of the lens surfaces, is greater than the absolute value of the radius of curvature of the third lens surface 221, which is the other lens surface. An antireflection film may be provided at each of the third lens surface 221 and the fourth lens surface 222.

### Comparison Between Embodiment 5 and Comparative Example

The beam distribution of the beam having exited out of the lens group 20 in the projector 1D according to Embodiment 5 and the beam distribution of the beam having exited out of the lens 60 in the projector 100 according to Comparative Example were compared with each other by using the evaluation formula (1) described above, as in Embodiment 1.

Lens data on each of the lenses in Embodiment 5 set by LightTools are shown below. Reference character R represents the absolute value of the radius of curvature. Reference character D represents the axial inter-surface spacing. Reference character nd represents the refractive index.

### Embodiment 5

| | | R | | D | nd |
|---|---|---|---|---|---|
| Light source | | | | 60 mm | |
| | First lens surface | 145 | mm | 22 mm | 1.4936 |
| First lens | | | | | |
| | Second lens surface | 145 | mm | 4 mm | |
| | Third lens surface | 72.5 | mm | 22 mm | 1.4936 |
| Second lens | | | | | |
| | Fourth lens surface | ∞ | mm | 2 mm | |

| | | | | |
|---|---|---|---|---|
| Evaluation plane | Evaluation plane | ∞ | — | — |

Data on the focal length of each of the lenses in Embodiment 5 set by LightTools are shown below. Reference character f1 represents the focal length of the first lens 21. Reference character f2 represents the focal length of the second lens 22. Reference character f represents the combined focal length of the first lens 21 and the second lens 22.

### Embodiment 5

| | |
|---|---|
| f1 | 146.88 mm |
| f2 | 146.88 mm |
| f | 80.6 mm |

Lens data on the lens in Comparative Example set by LightTools are shown below. Reference character R represents the absolute value of the radius of curvature. Reference character D represents the axial inter-surface spacing. Reference character nd represents the refractive index.

| | | R | D | nd |
|---|---|---|---|---|
| Light source | | | 61 mm | |
| Lens | First lens surface | 79 mm | 48 mm | 1.4936 |
| | Second lens surface | 79 mm | 1 mm | |
| Evaluation plane | Evaluation plane | ∞ | — | — |

Data on the focal length of the lens in Comparative Example set by LightTools are shown below. Reference character f0 represents the focal length of the lens 60.

### Comparative Example

f0 80.0 mm

The tables below show illuminance corresponding to each position in the beam distribution of the beam having exited out of the second lens 22 of the lens group 20 in Embodiment 5 and illuminance corresponding to each position in the beam distribution of the beam having exited out of the lens 60 in Comparative Example at the evaluation plane set by LightTools. Note that the evaluation plane is set at the same position in Embodiment 5 and Comparative Example.

| | Imax | Iap | Ibp | Icp | Idp |
|---|---|---|---|---|---|
| Embodiment 5 | 10.5379 | 6.40605 | 6.42049 | 6.89823 | 6.88799 |
| Comparative | 9.01271 | 8.10002 | 8.10153 | 9.33797 | 9.36489 |
| Example | | | | | |

| | Ias | Ibs | Ics | Ids |
|---|---|---|---|---|
| Embodiment 5 | 6.87069 | 6.88621 | 6.43178 | 6.42220 |
| Comparative | 9.35453 | 9.35640 | 8.08559 | 8.10883 |
| Example | | | | |

The evaluation values E of the lenses in Embodiment 5 and Comparative Example are shown below.

| | E |
|---|---|
| Embodiment 5 | 0.04419 |
| Comparative Example | 0.13919 |

The evaluation value E in Embodiment 5 is smaller than the evaluation value E in Comparative Example, as shown above. Therefore, when the focal length f of the lens group 20 in Embodiment 5 and the focal length f0 of the lens 60 in Comparative Example are set at the same value, the lens power of each of the lenses in Embodiment 5 is smaller than the lens power of the lens 60 in Comparative Example, and it is therefore found that the beam distribution of the beam having exited out of the second lens 22 of the lens group 20 in Embodiment 5 is smaller in terms of the amount of change in the shape of the beam distribution than the beam distribution of the beam having exited out of the lens 60 in Comparative Example. That is, the beam distribution of the beam having exited out of the second lens 22 of the lens group 20 in Embodiment 5 is closer to a circular shape than the beam distribution of the beam having exited out of the lens 60 in Comparative Example.

Furthermore, the lenses in Embodiment 5 can each be thinner than the lens 60 in Comparative Example.

### Effects and Advantages

In the projector 1D according to the present embodiment, the first lens surface 211 and the second lens surface 212 each have a convex shape. The third lens surface 221 has a convex shape. The fourth lens surface 222 has a planar shape. Out of the third lens surface 221 and the fourth lens surface 222, the absolute value of the radius of curvature of the fourth lens surface 222 is greater than the absolute value of the radius of curvature of the third lens surface 221. The thus configured projector 1D according to the present embodiment, in which the lens group 20 includes two lenses, can provide the same effects as those provided by Embodiment 1.

### Embodiment 6

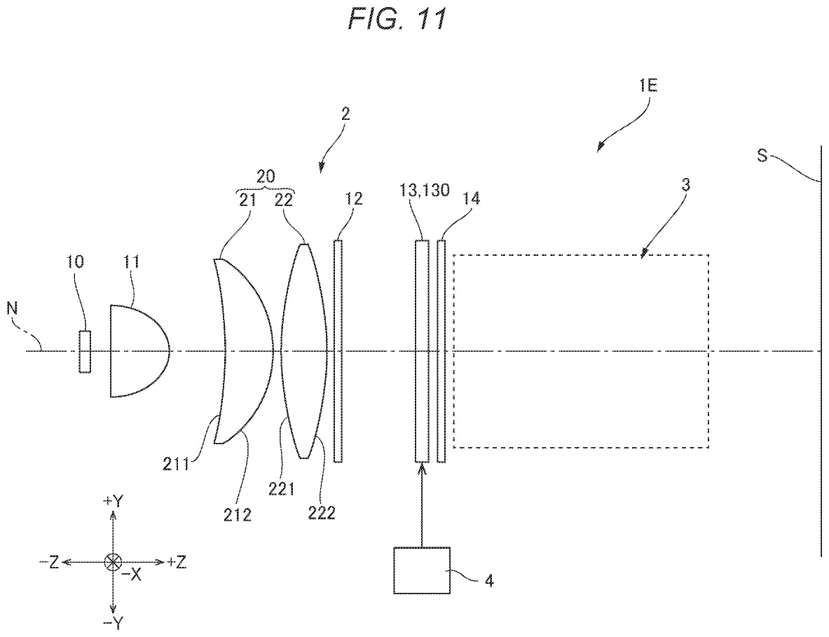

FIG. 11 is a schematic view of key parts of a projector 1E according to Embodiment 6. The projector 1E according to Embodiment 6 differs from the projector 1 according to Embodiment 1 in terms of the shape of the first lens 21 of the lens group 20. Therefore, in Embodiment 6, the same configurations as those in Embodiment 1 have the same reference characters, and no description of the same configurations will be made in some cases.

The lens group 20 includes a plurality of lenses, as shown in FIG. 11. In the present embodiment, the lens group 20 includes two lenses. The two lenses include the first lens 21 disposed at the side facing the light source 10, and the second lens 22 disposed at a position shifted from the first lens 21 toward the liquid crystal panel 130.

The first lens 21 is made of resin. The first lens 21 has positive power. The first lens 21 has the first lens surface 211 facing the light source 10, and the second lens surface 212 facing the liquid crystal panel 130. The first lens surface 211 has a concave shape. The second lens surface 212 has a convex shape. The absolute value of the radius of curvature of the second lens surface 212, which is one of the first lens surface 211 and the second lens surface 212, is smaller than the absolute value of the radius of curvature of the first lens surface 211, which is the other lens surface. Note that an antireflection film may be provided at each of the first lens surface 211 and the second lens surface 212.

The second lens 22 has the third lens surface 221 facing the light source 10, and the fourth lens surface 222 facing the liquid crystal panel 130. The third lens surface 221 and the fourth lens surface 222 each have a convex shape. An antireflection film may be provided at each of the third lens surface 221 and the fourth lens surface 222.

### Comparison Between Embodiment 6 and Comparative Example

The beam distribution of the beam having exited out of the lens group 20 in the projector 1E according to Embodiment 6 and the beam distribution of the beam having exited out of the lens 60 in the projector 100 according to Comparative Example were compared with each other by using the evaluation formula (1) described above, as in Embodiment 1.

Lens data on each of the lenses in Embodiment 6 set by LightTools are shown below. Reference character R represents the absolute value of the radius of curvature. Reference character D represents the axial inter-surface spacing. Reference character nd represents the refractive index.

### Embodiment 6

| | | R | D | nd |
|---|---|---|---|---|
| Light source | | | 60 mm | |
| | First lens surface | 170 mm | 22 mm | 1.4936 |
| First lens | | | | |
| | Second lens surface | 51 mm | 4 mm | |
| | Third lens surface | 145 mm | 22 mm | 1.4936 |
| Second lens | | | 2 mm | |
| | Fourth lens surface | 145 mm | | |
| Evaluation plane | Evaluation plane | ∞ | — | — |

Data on the focal length of each of the lenses in Embodiment 6 set by LightTools are shown below. Reference character f1 represents the focal length of the first lens 21. Reference character f2 represents the focal length of the second lens 22. Reference character f represents the combined focal length of the first lens 21 and the second lens 22.

### Embodiment 6

| | |
|---|---|
| f1 | 147.60 mm |
| f2 | 146.88 mm |
| f | 80.3 mm |

Lens data on the lens in Comparative Example set by LightTools are shown below. Reference character R represents the absolute value of the radius of curvature. Reference character D represents the axial inter-surface spacing. Reference character nd represents the refractive index.

### Comparative Example

| | | R | D | nd |
|---|---|---|---|---|
| Light source | | | 61 mm | |
| | First lens surface | 79 mm | 48 mm | 1.4936 |
| Lens | Second lens surface | 79 mm | 1 mm | |
| Evaluation plane | Evaluation plane | ∞ | — | — |

Data on the focal length of the lens in Comparative Example set by LightTools are shown below. Reference character f0 represents the focal length of the lens 60.

### Comparative Example

f0 80.0 mm

The tables below show illuminance corresponding to each position in the beam distribution of the beam having exited out of the second lens 22 of the lens group 20 in Embodiment 6 and illuminance corresponding to each position in the beam distribution of the beam having exited out of the lens 60 in Comparative Example at the evaluation plane set by LightTools. Note that the evaluation plane is set at the same position in Embodiment 6 and Comparative Example.

| | Imax | Iap | Ibp | Icp | Idp |
|---|---|---|---|---|---|
| Embodiment 6 | 9.00191 | 8.33265 | 8.34931 | 8.59010 | 8.60337 |
| Comparative Example | 9.01271 | 8.10002 | 8.10153 | 9.33797 | 9.36489 |

| | Ias | Ibs | Ics | Ids |
|---|---|---|---|---|
| Embodiment 6 | 8.60735 | 8.62459 | 8.31597 | 8.32877 |
| Comparative Example | 9.35453 | 9.35640 | 8.08559 | 8.10883 |

The evaluation values E of the lenses in Embodiment 6 and Comparative Example are shown below.

| | E |
|---|---|
| Embodiment 6 | 0.03051 |
| Comparative Example | 0.13919 |

The evaluation value E in Embodiment 6 is smaller than the evaluation value E in Comparative Example, as shown above. Therefore, when the focal length f of the lens group 20 in Embodiment 6 and the focal length f0 of the lens 60 in Comparative Example are set at the same value, the lens power of each of the lenses in Embodiment 6 is smaller than the lens power of the lens 60 in Comparative Example, and it is therefore found that the beam distribution of the beam having exited out of the second lens 22 of the lens group 20 in Embodiment 6 is smaller in distribution than the beam distribution of the beam having exited out of the lens 60 in Comparative Example. That is, the beam distribution of the beam having exited out of the second lens 22 of the lens group 20 in Embodiment 6 is closer to a circular shape than the beam distribution of the beam having exited out of the lens 60 in Comparative Example.

Furthermore, the lenses in Embodiment 6 can each be thinner than the lens 60 in Comparative Example.

### Effects and Advantages

In the projector 1E according to the present embodiment, the first lens surface 211 has a concave shape. The second lens surface 212 has a convex shape. The third lens surface 221 and the fourth lens surface 222 each have a convex shape. Out of the first lens surface 211 and the second lens surface 212, the absolute value of the radius of curvature of the second lens surface 212 is smaller than the absolute value of the radius of curvature of the first lens surface 211. The thus configured projector 1E according to the present embodiment, in which the lens group 20 includes two lenses, can provide the same effects as those provided by Embodiment 1.

### Embodiment 7

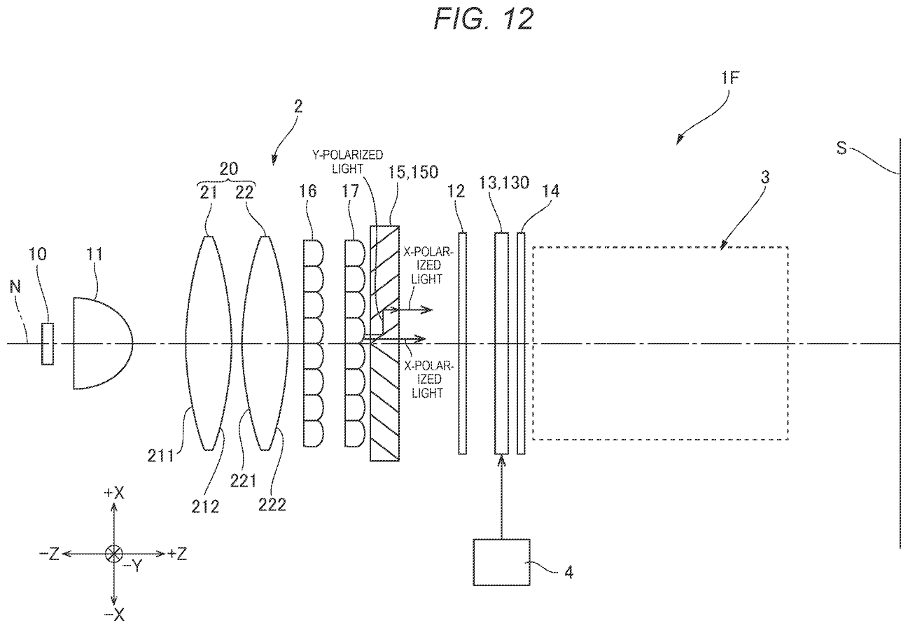

FIG. 12 is a schematic view of key parts of a projector 1F according to Embodiment 7. The projector 1F according to Embodiment 7 differs from the projector 1 according to Embodiment 1 in that the projector 1F includes a polarization conversion optical system. Therefore, in Embodiment 7, the same configurations as those in Embodiment 1 have the same reference characters, and no description of the same configurations will be made in some cases.

The image formation unit 2 includes the light source 10, the pickup lens 11, the lens group 20, a first optical integration lens 16, a second optical integration lens 17, a polarization conversion optical system 15, the light-incident-side polarizer 12, the light modulator 13, and the light-exiting-side polarizer 14, as shown in FIG. 12.

The first optical integration lens 16 and the second optical integration lens 17 are disposed at the light exiting side of the lens group 20. The first optical integration lens 16 and the second optical integration lens 17 each include a plurality of lens elements arranged in an array. The first optical integration lens 16 divides the beam from the lens group 20 into a plurality of beams. The second optical integration lens 17 brings the beams from the first optical integration lens 16 into focus in the vicinity of the polarization conversion optical system 15.

The polarization conversion optical system 15 is disposed at the light exiting side of the second optical integration lens 17. The polarization conversion optical system 15 converts the polarization directions of the beam having exited out of the lens group 20. The polarization conversion optical system 15 is a polarization converter 150. The polarization converter 150 is an optical element formed of a polarization beam splitter (PBS) array. The polarization converter 150 includes, although not shown, polarization separation layers that directly transmit one linearly polarized light component (X-polarized light, for example) out of the polarized light components contained in the beam having exited out of the lens group 20 and reflect the other linearly polarized light component (Y-polarized light, for example) in a direction perpendicular to the optical axis, reflection layers that reflect the other linearly polarized light component reflected off the polarization separation layers in the direction parallel to the optical axis, and retardation films (half-wave films, for example) that convert the other linearly polarized light component (Y-polarized light, for example) reflected off the reflection layers into the one linearly polarized light component (X-polarized light, for example). The polarization converter 150 in the present embodiment converts the Y-polarized light out of the polarized light components contained in the beam incident thereon into the X-polarized light. More specifically, the polarization converter 150 transmits the X-polarized light out of the polarized light components contained in the beam incident on the polarization converter 150, converts the Y-polarized light into the X-polarized light, and outputs the converted X-polarized light toward the light-incident-side polarizer 12.

### Effects and Advantages

The projector 1F according to the present embodiment includes the polarization conversion optical system 15, which is disposed between the lens group 20 and the light-incident-side polarizer 12 and converts the polarization directions of the beam having exited out of the lens group 20. The polarization conversion optical system 15 is the polarization converter 150. Therefore, as compared with the configuration without the polarization converter 150, the polarization converter 150 converts the Y-polarized light contained in the beam having exited out of the lens group 20 into the X-polarized light that is used as the beam to be incident on the liquid crystal panel 130, so that the projector 1F according to the present embodiment allows an increase in the amount of beam incident on the liquid crystal panel 130. Note that the polarization conversion optical system 15 in the present embodiment can be used in Embodiments 1 to 6.

### Embodiment 8

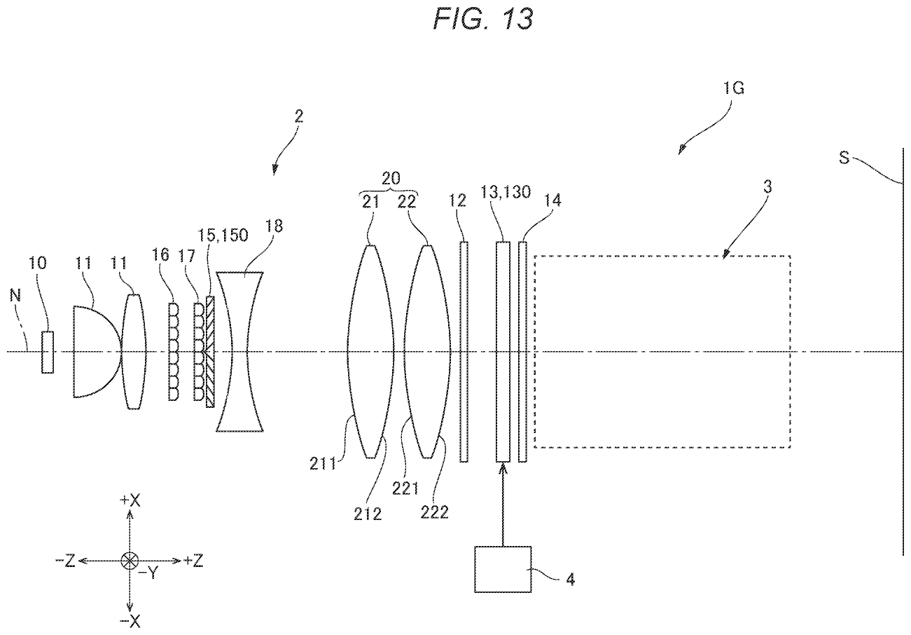

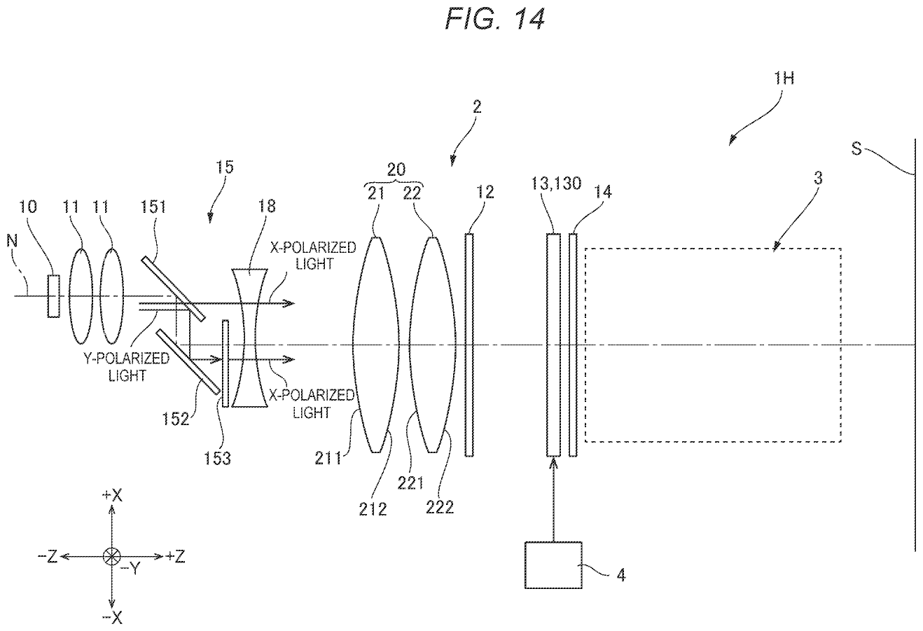

FIG. 13 is a schematic view of key parts of a projector 1G according to Embodiment 8. The projector 1G according to Embodiment 8 differs from the projector 1F according to Embodiment 7 in that the polarization conversion optical system is disposed in a different position. Therefore, in Embodiment 8, the same configurations as those in Embodiment 1 have the same reference characters, and no description of the same configurations will be made in some cases.

The image formation unit 2 includes the light source 10, the pickup lens 11, the first optical integration lens 16, the second optical integration lens 17, the polarization conversion optical system 15, an enlarging lens 18, the lens group 20, the light-incident-side polarizer 12, the light modulator 13, and the light-exiting-side polarizer 14, as shown in FIG. 13.

The first optical integration lens 16 and the second optical integration lens 17 are disposed at the light exiting side of the pickup lens 11. The first optical integration lens 16 and the second optical integration lens 17 each include a plurality of lens elements arranged in an array. The first optical integration lens 16 divides the beam from the pickup lens 11 into a plurality of beams. The second optical integration lens 17 brings the beams from the first optical integration lens 16 into focus in the vicinity of the polarization conversion optical system 15.

The polarization conversion optical system 15 is disposed at the light exiting side of the second optical integration lens 17. The polarization conversion optical system 15 converts the polarization directions of the beam output from the light source 10. The polarization conversion optical system 15 is the polarization converter 150. The polarization converter 150 in the present embodiment transmits the X-polarized light out of the polarized light components contained in the beam incident on the polarization converter 150, converts the Y-polarized light into the X-polarized light, and outputs the converted X-polarized light toward the light-incident-side polarizer 12. The enlarging lens 18 enlarges the beam incident from the polarization converter 150 and outputs the enlarged beam toward the light-incident-side polarizer 12.

### Effects and Advantages

The projector 1G according to the present embodiment includes the polarization conversion optical system 15, which is disposed between the light source 10 and the lens group 20 and converts the polarization directions of the beam output from the light source 10. The polarization conversion system optical 15 is the polarization converter 150. Therefore, as compared with the configuration without the polarization converter 150, the polarization conversion optical system 15 converts the Y-polarized light contained in the beam output from the light source 10 into the X-polarized light that is used as the beam to be incident on the liquid crystal panel 130, so that the projector 1G according to the present embodiment allows an increase in the amount of the beam incident on the liquid crystal panel 130. Note that the polarization conversion optical system 15 in the present embodiment can be used in Embodiments 1 to 6.

### Embodiment 9

FIG. 14 is a schematic view of key parts of a projector 1H according to Embodiment 9. The projector 1H according to Embodiment 9 differs from the projector 1G according to Embodiment 8 in that the polarization conversion optical system is not a polarization converter. Therefore, in Embodiment 9, the same configurations as those in Embodiment 1 have the same reference characters, and no description of the same configurations will be made in some cases.

The image formation unit 2 includes the light source 10, the pickup lens 11, the polarization conversion optical system 15, the enlarging lens 18, the lens group 20, the light-incident-side polarizer 12, the light modulator 13, and the light-exiting-side polarizer 14, as shown in FIG. 14.

The polarization conversion optical system 15 is disposed at the light exiting side of the pickup lens 11. The polarization conversion optical system 15 converts the polarization directions of the beam output from the light source 10. More specifically, the polarization conversion optical system 15 converts the Y-polarized light out of the polarized light components contained in the beam incident on the polarization conversion optical system 15 into the X-polarized light. The polarization conversion optical system 15 includes a polarization beam splitter 151, a total reflection mirror 152, and a retardation film 153. The polarization beam splitter 151 directly transmits one linearly polarized light component (X-polarized light, for example) out of the polarized light components contained in the beam incident thereon, and reflects the other linearly polarized light component (Y-polarized light, for example) in a direction perpendicular to the optical axis N. In the present embodiment, the polarization beam splitter 151 transmits the X-polarized light toward the enlarging lens 18 and reflects the Y-polarized light toward the total reflection mirror 152. The total reflection mirror 152 reflects the Y-polarized light reflected off the polarization beam splitter 151 in the direction parallel to the optical axis N. The retardation film 153 (half-wave film, for example) converts the Y-polarized light reflected off the total reflection mirror 152 into the X-polarized light and outputs the converted X-polarized light toward the enlarging lens 18. The enlarging lens 18 enlarges the beam incident from the polarization conversion optical system 15 and outputs the enlarged beam toward the light-incident-side polarizer 12.

### Effects and Advantages

The projector 1H according to the present embodiment includes the polarization conversion optical system 15, which is disposed between the light source 10 and the lens group 20 and converts the polarization directions of the beam output from the light source 10. The polarization conversion optical system 15 includes the polarization beam splitter 151, which directly transmits the X-polarized light out of the polarized light components contained in the beam incident thereon, and reflects the Y-polarized light, which is the other linearly polarized light component, in a direction perpendicular to the optical axis N, the total reflection mirror 152, which reflects the Y-polarized light reflected off the polarization beam splitter 151 in the direction parallel to the optical axis N, and the retardation film 153, which converts the Y-polarized light reflected off the total reflection mirror 152 into the X-polarized light. Therefore, the polarization conversion optical system 15 converts the Y-polarized light contained in the beam output from the light source 10 into the X-polarized light that is used as the beam to be incident on the liquid crystal panel 130, so that the projector 1H according to the present embodiment allows an increase in the amount of the beam incident on the liquid crystal panel 130. Note that the polarization conversion optical system 15 in the present embodiment can be used in Embodiments 1 to 6.

### Embodiment 10

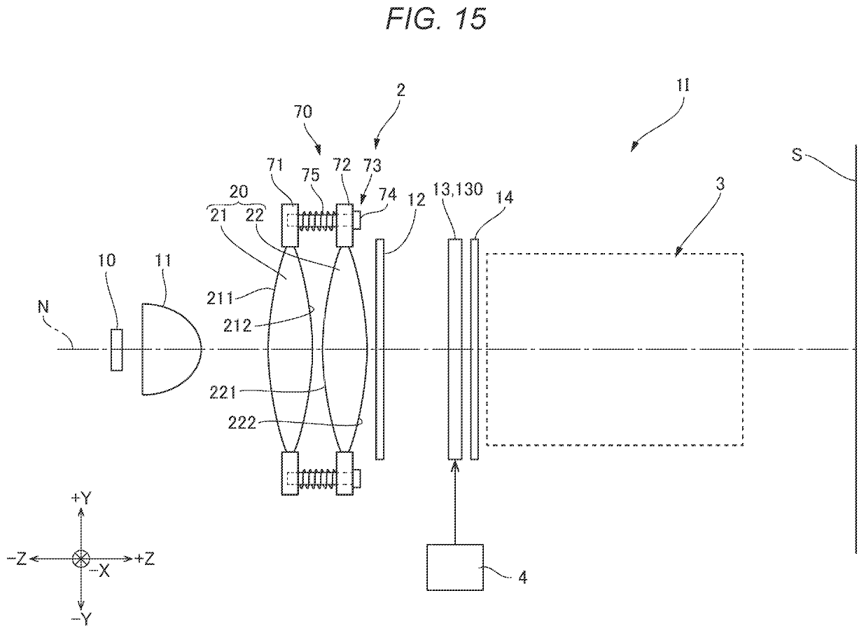

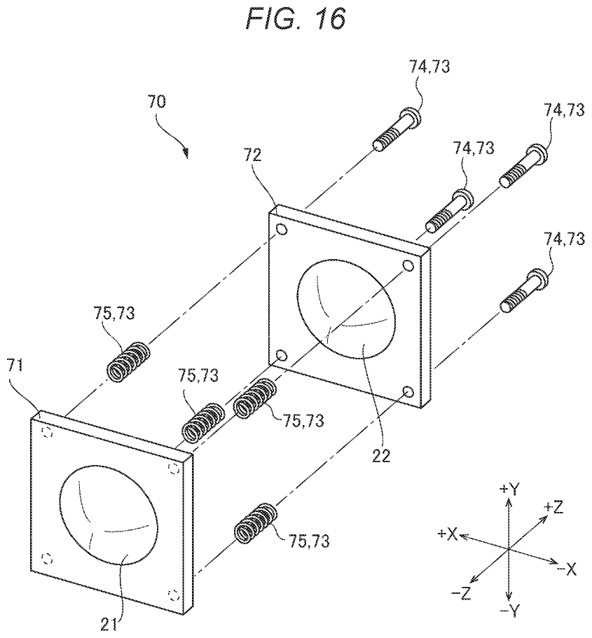

FIG. 15 is a schematic view of key parts of a projector 1I according to Embodiment 10. FIG. 16 is an exploded perspective view of an adjustment mechanism. The projector 1I according to Embodiment 10 differs from the projector 1 according to Embodiment 1 in that the projector 1I includes an adjustment mechanism 70. Therefore, in Embodiment 10, the same configurations as those in Embodiment 1 have the same reference characters, and no description of the same configurations will be made in some cases.

The image formation unit 2 includes the light source 10, the pickup lens 11, the lens group 20, the light-incident-side polarizer 12, the light modulator 13, the light-exiting-side polarizer 14, and the adjustment mechanism 70, as shown in FIG. 15. The adjustment mechanism 70 changes the axial distance between the first lens 21 and the second lens 22.

The adjustment mechanism 70 includes a first frame 71, which holds the first lens 21, a second frame 72, which holds the second lens 22, and an adjuster 73, which adjusts the distance between the first frame 71 and the second frame 72, as shown in FIGS. 15 and 16. The first frame 71 holds an outer circumferential portion of the first lens 21. The first frame 71 is fixed to a body or any other portion of the projector 1I. The second frame 72 holds an outer circumferential portion of the second lens 22. The second frame 72 is fixed to the first frame 71. The adjuster 73 includes adjustment screws 74, which fix the second frame 72 to the first frame 71, and springs 75, which are disposed between the first frame 71 and the second frame 72 and through which the adjustment screws 74 are inserted. In the present embodiment, the number of adjustment screws 74 and springs 75 is four. The adjustment screws 74 are inserted through holes provided in the second frame 72 and screwed into screw holes provided in the first frame 71. The distance between the first frame 71 and the second frame 72 is adjusted by rotating the adjustment screws 74. In this process, the springs 75 apply an urging force to the first frame 71 and the second frame 72.

### Effects and Advantages

The projector 1I according to the present embodiment includes the adjustment mechanism 70, which changes the axial distance between the first lens 21 and the second lens 22. The distance between the first lens 21 and the second lens 22 is therefore readily adjusted when the projector 1I is manufactured. Note that the adjustment mechanism 70 can be used in Embodiments 1 to 9.

### Other Embodiments

In the embodiments described above, the lens group 20 includes the first lens 21 and the second lens 22, and the number of lenses provided in the lens group 20 is not limited to two. The lens group 20 may include three or four lenses.

The adjustment mechanism 70 does not necessarily have the configuration described above. The adjustment mechanism 70 only needs to have a configuration that can change the axial distance between the first lens 21 and the second lens 22.

It is preferable that the first lens 21 and the second lens 22 are disposed in succession. The size of the lens group 20 can thus be reduced.

It is preferable that the maximum effective lens width of the lens disposed at a position closest to the light modulator 13 in the lens group 20 (second lens 22) is greater than or equal to the maximum width of the effective display surface of the liquid crystal panel 130 (diagonal in the case where effective display surface has rectangular shape). The parallelized beam from the lens group 20 can thus be more reliably incident on the entire effective display surface of the liquid crystal panel 130.

### Summary of Present Disclosure

The present disclosure will be summarized below as additional remarks.

### Additional Remark 1

A projector including a light source, a lens group that parallelizes a beam output from the light source, a light-incident-side polarizer that transmits the beam that exits out of the lens group, a light modulator that modulates the beam passing through the light-incident-side polarizer to form a projection image, a light-exiting-side polarizer that transmits the beam modulated by the light modulator, and a projection lens that projects the beam passing through the light-exiting-side polarizer, the light modulator including first sub-pixels on which blue light is incident, second sub-pixels on which green light is incident, and third sub-pixels on which red light is incident, the lens group including two lenses each having positive power, and the two lenses each have a convex surface.

The configuration described above, in which the lens group has two lenses, allows a decrease in the lens power per lens as compared with the case where the lens group includes one lens. The angle of incidence of the beam incident on each of the lenses of the lens group can thus be reduced, so that the change in the shape of the beam distribution of the beam having exited out of the lens group can be reduced. As a result, since the beam distribution of the beam having exited out of the lens group has nearly a circular shape, the dark peripheral portion of the projection image formed by the light modulator can be suppressed. The projector can therefore project an enlarged image having uniform brightness.

### Additional Remark 2

The projector described in the additional remark 1, in which the two lenses include a first lens disposed at the side facing the light source and a second lens disposed at a position shifted from the first lens toward the light modulator, the first lens has a first lens surface facing the light source and a second lens surface facing the light modulator, and the absolute value of the radius of curvature of one of the first and second lens surfaces is greater than the absolute value of the radius of curvature of the other lens surface.

### Additional Remark 3

The projector described in the additional remark 1, in which the two lenses include a first lens disposed at the side facing the light source and a second lens disposed at a position shifted from the first lens toward the light modulator, the second lens has a third lens surface facing the light source and a fourth lens surface facing the light modulator, and the absolute value of the radius of curvature of one of the third and fourth lens surfaces is greater than the absolute value of the radius of curvature of the other lens surface.

### Additional Remark 4

The projector described in the additional remark 2, in which the second lens has a third lens surface facing the light source and a fourth lens surface facing the light modulator, the one lens surface has a convex shape, and the other lens surface has a planar shape, and the third and fourth lens surfaces each have a convex shape.

### Additional Remark 5

The projector described in the additional remark 3, in which the first lens has a first lens surface facing the light source and a second lens surface facing the light modulator, the first and second lens surfaces each have a convex shape, and the one lens surface has a convex shape, and the other lens surface has a planar shape.

### Additional Remark 6

The projector described in the additional remark 1, in which the two lenses include a first lens disposed at the side facing the light source and a second lens disposed at a position shifted from the first lens toward the light modulator, the first lens has a first lens surface facing the light source and a second lens surface facing the light modulator, the second lens has a third lens surface facing the light source and a fourth lens surface facing the light modulator, the first, second, third, and fourth lens surfaces each have a convex shape, and the first, second, third, and fourth lens surfaces have the same absolute value of the radius of curvature.

The first and second lenses can thus have the same shape. The production cost of the first and second lenses can therefore be suppressed as compared with a case where the lenses have different shapes.

### Additional Remark 7

The projector described in the additional remark 1, in which the two lenses include a first lens disposed at the side facing the light source and a second lens disposed at a position shifted from the first lens toward the light modulator, and the focal length of the first lens is shorter than the focal length of the second lens.

The change in the shape of the beam distribution of the beam having exited out of the second lens can thus be further reduced.

### Additional Remark 8

The projector described in any one of the additional remarks 2 to 7, further including an adjustment mechanism that changes the axial distance between the first lens and the second lens.

The axial distance between the first lens and the second lens is therefore readily adjusted when the projector is manufactured.

### Additional Remark 9

The projector described in any one of the remarks 1 to 8, in which the two lenses are made of resin.

The production cost of the two lenses can therefore be suppressed as compared with the case where the two lenses are made of glass.

### Additional Remark 10

The projector described in any one of the remarks 1 to 9, further including a polarization conversion optical system that is disposed between the light source and the lens group and converts the polarization directions of the beam output from the light source.

The polarization conversion optical system thus converts the polarization directions of the beam output from the light source, so that the projector according to the present embodiment allows an increase in the amount of beam incident on the light modulator, as compared with the configuration without the polarization conversion optical system.

### Additional Remark 11

The projector described in any one of the remarks 1 to 9, further including a polarization conversion optical system that is disposed between the lens group and the light-incident-side polarizer and converts the polarization directions of the beam that exits out of the lens group.

The polarization conversion optical system thus converts the polarization directions of the beam output from the lens group, so that the projector according to the present embodiment allows an increase in the amount of beam incident on the light modulator, as compared with the configuration without the polarization conversion optical system.

### Additional Remark 12

The projector described in the remark 10, in which the polarization conversion optical system includes a polarization beam splitter that directly transmits one linearly polarized light component out of the polarized light components contained in the beam incident thereon and reflects the other linearly polarized light component in a direction perpendicular to the optical axis, a total reflection mirror that reflects the other linearly polarized light component reflected off the polarization beam splitter in the direction parallel to the optical axis, and a retardation film that converts the other linearly polarized light component reflected off the total reflection mirror into the one linearly polarized light component.

What is claimed is:

1. A projector comprising:
a light source;
a lens group that parallelizes a beam output from the light source;
a light-incident-side polarizer that transmits the beam that exits out of the lens group;
a light modulator that modulates the beam passing through the light-incident-side polarizer to form a projection image;
a light-exiting-side polarizer that transmits the beam modulated by the light modulator; and
a projection lens that projects the beam passing through the light-exiting-side polarizer,
wherein the light modulator includes first sub-pixels on which blue light is incident, second sub-pixels on which green light is incident, and third sub-pixels on which red light is incident,
the lens group includes two lenses each having positive power, and
the two lenses each have a convex surface.

2. The projector according to claim 1,
wherein the two lenses include a first lens disposed at a side facing the light source and a second lens disposed at a position shifted from the first lens toward the light modulator,
the first lens has a first lens surface facing the light source and a second lens surface facing the light modulator, and
an absolute value of a radius of curvature of one of the first and second lens surfaces is greater than an absolute value of a radius of curvature of the other lens surface.

3. The projector according to claim 1,
wherein the two lenses include a first lens disposed at a side facing the light source and a second lens disposed at a position shifted from the first lens toward the light modulator,
the second lens has a third lens surface facing the light source and a fourth lens surface facing the light modulator, and
an absolute value of a radius of curvature of one of the third and fourth lens surfaces is greater than an absolute value of a radius of curvature of the other lens surface.

4. The projector according to claim 2,
wherein the second lens has a third lens surface facing the light source and a fourth lens surface facing the light modulator,
the one lens surface has a convex shape, and the other lens surface has a planar shape, and
the third and fourth lens surfaces each have a convex shape.

5. The projector according to claim 3,
wherein the first lens has a first lens surface facing the light source and a second lens surface facing the light modulator,
the first and second lens surfaces each have a convex shape, and
the one lens surface has a convex shape, and the other lens surface has a planar shape.

6. The projector according to claim 1,
wherein the two lenses include a first lens disposed at a side facing the light source and a second lens disposed at a position shifted from the first lens toward the light modulator,
the first lens has a first lens surface facing the light source and a second lens surface facing the light modulator,
the second lens has a third lens surface facing the light source and a fourth lens surface facing the light modulator,
the first, second, third, and fourth lens surfaces each have a convex shape, and
the first, second, third, and fourth lens surfaces have the same absolute value of a radius of curvature.

7. The projector according to 1,
wherein the two lenses include a first lens disposed at a side facing the light source and a second lens disposed at a position shifted from the first lens toward the light modulator, and
a focal length of the first lens is shorter than a focal length of the second lens.

8. The projector according to claim 2, further comprising an adjustment mechanism that changes an axial distance between the first lens and the second lens.

9. The projector according to claim 1, wherein the two lenses are made of resin.

10. The projector according to claim 1, further comprising a polarization conversion optical system that is disposed between the light source and the lens group and converts polarization directions of the beam output from the light source.

11. The projector according to claim 1, further comprising a polarization conversion optical system that is disposed between the lens group and the light-incident-side polarizer and converts polarization directions of the beam that exits out of the lens group.

12. The projector according to claim 10, wherein the polarization conversion optical system includes a polarization beam splitter that directly transmits one linearly polarized light component out of polarized light components contained in the beam incident thereon and reflects another linearly polarized light component in a direction perpendicular to an optical axis, a total reflection mirror that reflects the other linearly polarized light component reflected off the polarization beam splitter in a direction parallel to the optical axis, and a retardation film that converts the other linearly polarized light component reflected off the total reflection mirror into the one linearly polarized light component.
